(19) United States
(12) Patent Application Publication
(10) Pub. No.: US 2026/0067056 A1
(43) Pub. Date: Mar. 5, 2026

(54) WIRELESS POWER TRANSFER TO USER EQUIPMENT

(71) Applicant: Telefonaktiebolaget LM Ericsson (publ), Stockholm (SE)

(72) Inventors: Iran MESQUITA BRAGA JUNIOR, Fortaleza (BR); Roberto Pinto ANTONIOLI, Fortaleza - Ceará (BR); Gabor FODOR, Hässelby (SE); Yuri C.B. SILVA, Fortaleza - CE (BR); Walter DA CRUZ FREITAS JUNIOR, Fortaleza - Ceará (BR)

(73) Assignee: Telefonaktiebolaget LM Ericsson (publ), Stockholm (SE)

(21) Appl. No.: 19/106,663

(22) PCT Filed: Aug. 30, 2022
(86) PCT No.: PCT/EP2022/074005

§ 371 Date: Feb. 26, 2025

(51) Int. Cl. H04L 5/14; H04B 7/0413

(52) U.S. Cl. CPC H04L 5/14; H04B 7/0413

(57) ABSTRACT

There is provided techniques for wireless power transfer from APs to UEs. The APs provide network access in a D-MIMO network to the UEs. The D-MIMO network is operated in TDD mode. A method is performed by a centralized node in the D-MIMO network. The method comprises sending UE-configuration destined to the UEs. The UE-configuration instructs the UEs to, during a time interval of a frame, simultaneously transmit uplink pilot signals and perform wireless energy harvesting on energy signals. The method comprises sending AP-configuration to the APs. The AP-configuration instructs the APs to, during the time interval of the frame, simultaneously transmit the energy signals towards the UEs and receive the uplink pilot signals from the UEs.

### TECHNICAL FIELD

Embodiments presented herein relate to a method, a centralized node, a computer program, and a computer program product for wireless power transfer from access points to user equipment. Further embodiments presented herein relate to a method, an access point, a computer program, and a computer program product for wireless power transfer to user equipment. Further embodiments presented herein relate to a method, a user equipment, a computer program, and a computer program product for wireless power transfer to the user equipment.

### BACKGROUND

Multi-antenna techniques can significantly increase the data rates and reliability of a wireless communication system. The performance is in particular improved if both the transmitter and the receiver are equipped with multiple antennas, which results in a multiple-input multiple-output (MIMO) communication channel. Such systems and/or related techniques are commonly referred to as MIMO systems, or just MIMO for short.

Distributed MIMO (D-MIMO, also referred to as cell-free massive MIMO, RadioStripes, RadioWeaves, and ubiquitous MIMO) is a candidate for the physical layer of the 6^{th} generation (6G) telecommunication system. D-MIMO is based on geographically distributing the antennas of the network and configure them to operate phase-coherently together. Deployments of D-MIMO networks may be used to provide good coverage and high capacity for areas with high traffic requirements such as factory buildings, stadiums, office spaces and airports, just to mention a few examples.

In a typical architecture, multiple access points (APs) are interconnected and configured such that two or more APs can cooperate in coherent decoding of data from a given user equipment (UE) served by the network, and such that two or more APs can cooperate in coherent transmission of data to a UE. The APs might thus collectively define the access part of the D-MIMO network. Each AP has one or more antenna panel. Each antenna panel might comprise multiple antenna elements that are configured to operate phase-coherently together.

FIG. 1 is a schematic diagram illustrating a communication network 100 where embodiments presented herein can be applied. The communication network 100 comprises K APs 1400a: 1400K, six of which are identified as AP-#0, . . . AP-#5. In this respect, the herein disclosed embodiments are not limited to any particular number of APs 1400a:1400K. Each AP 1400a:1400K could be a (radio) access network node, radio base station, base transceiver station, node B (NB), evolved node B (eNB), gNB, integrated access and backhaul (IAB) node, one or more distributed antenna, or the like. The APs 1400a:1400K operatively connected over interfaces to one or more centralized nodes 1200a, 1200b, denoted CPU-#0, CPU-#1, which could represent an interface to a core network. The centralized node 1200a, 1200b could be a (radio) base station, or the like. The APs 1400a:1400K are configured to provide network access to user equipment (UE) 1600a:1600M, five of which are identified as UE-#0, . . . UE-#4. Each such 1600a:1600M could be any of a portable wireless device, mobile station, mobile phone, handset, wireless local loop phone, smartphone, laptop computer, tablet computer, wireless modem, wireless sensor device, Internet of Things (IoT) device, network equipped vehicle, or the like. Each such UE 1600a:1600M is configured for wireless communication with one or more of the APs 1400a:1400K. In some aspects, the communications network 100 is a D-MIMO network. Hence, in some examples, the APs 1400a:1400K are part of a D-MIMO network. AP-#1 is illustrated to serve UE-#0 and UE-#1. AP-#1 also suffers from AP-AP interference from AP-#0 and AP-#2, from AP-UE interference from UE-#2, and from AP self-interference from itself. Further, UE-#3 is served by AP-#3 and AP-#4. Further, UE-#3 suffers from AP-UE interference from AP-#5, from UE-UE interference from UE-#2 and UE-#4, and from UE self-interference from itself.

Energy harvesting (EH) is arising as a promising technology for proving near-perpetual operation to low-powered user equipment, such as IoT devices. Due to the uncertainties on EH from natural resources, wireless power transfer (WPT) is a suitable alternative to tackle the limited energy storage issue of low-powered user equipment. Indeed, WPT allows low-powered user equipment, such as battery powered user equipment, to charge their battery by means of radio frequency signals. Moreover, D-MIMO networks can be utilized to reduce the impact of path losses experienced in wireless scenarios and improve the energy harvesting opportunities of user equipment at the cell-edges. In practice, WPT can be implemented by several technologies, such as inductive coupling, magnetic resonate coupling, and electromagnetic (EM) radiation, for short-/mid-/long-range applications, respectively.

In general terms, a given transceiver device cannot properly decode a received signal in a given frequency channel at the same time as the given transceiver device is also transmitting a transmit signal on the same frequency channel without the transmit signal impacting the reception of the received signal. Indeed, the transmit signal acts as a strong interfering source to the received signal. For the transceiver, the transmit signal can therefore be regarded as self-interference (SI). Frequency division duplexing (FDD) and time division duplexing (TDD) techniques can be used to mitigate SI. Further, even though recent advances in hardware and signal processing have allowed full-duplex (FD) communication to be possible, i.e., to enable a transceiver device to transmit and receive data simultaneously on the same frequency channel, the complexity of the hardware in the user equipment is still a bottleneck. In fact, antenna arrangements, as well as signal processing in both analog and digital domains required to obtain SI cancelation are complex to implement in the context of low-powered user equipment.

Simultaneous wireless information and power transfer (SWIPT) enables information and energy to be carried simultaneously. SWIPT and FD can be combined to obtain advantages in terms of spectral and energy efficiency. In contrast to a conventional FD system, in which SI is harmful, SI can be beneficial in terms of energy source for harvesting energy in systems where FD and SWIPT are combined. SWIPT schemes can be classified into two categories according to receiver types; time switching (TS) SWIPT schemes and power splitting (PS) SWIPT schemes. In TS SWIPT schemes the downlink time is divided into an EH phase and an information detection phase.

The frame structure 200a for a TS SWIPT scheme is illustrated in FIG. 2(a). The frame thus is composed of four parts; a first part P1 for channel estimation 210, a second part P2 for energy harvesting 212, a third part P3 for downlink data transmission 214, and a fourth part P4 for uplink data transmission 216. Accordingly, in the first part the UEs sends uplink pilot signals for the APs to measure on to estimate the channel between the APs and the UEs. In the second part the APs send energy signals on which the UEs perform energy harvesting. In the third part the APs send downlink data towards the UEs, and in the fourth part the UEs send uplink data towards the APs. Even though the receiver requires only a simple switcher, i.e., low hardware complexity, the frame structure in FIG. 2(a) presents low performance in terms of spectral efficiency and harvested energy due to waste of resources. Indeed, less resources are dedicated to channel estimation and data transmission.

The frame structure 200b for a PS SWIPT scheme is illustrated in FIG. 2(b). The frame thus is composed of three parts; a first part P1 for channel estimation 218, a second part P2 for joint energy harvesting 220 and downlink data transmission 222, and a third part P3 for uplink data transmission 224. Accordingly, in the second part the APs send downlink data towards the UEs where the UEs both receive the downlink data and perform energy harvesting on the received downlink data. In general, PS SWIPT scheme presents better performance than the TS SWIPT scheme since the TS SWIPT scheme can be treated as a special case of PS SWIPT scheme with binary split power ratios. However, the receiver in the UE needs a radio frequency signal splitter, and its structure is relatively complicated.

The frame structure 200c for a scheme where SWIPT is combined with FD is illustrated in FIG. 2(c). The frame thus is composed of three parts; a first part P1 for channel estimation 226, a second part P2 for joint energy harvesting 228 and uplink data transmission 234, and a third part P3 for joint energy harvesting 230, downlink data transmission 232, and uplink data transmission 234. When FD is assumed, besides the radio frequency signal splitter, the receiver in the UE also needs to perform SI canceling, which can be extremely complex for low-complexity UEs. This is further illustrated in FIG. 3 which schematically illustrates the transceiver 300 of a UE 1500m configured for SWIPT combined with FD. The transceiver comprises a transmit chain 310, a receiver chain 360, a circulator 320, an antenna, 330 and a 3-port element 340. A transmit signal is fed by the transmit chain 310 through the circulator 320 to the antenna 330 for transmission. A receive signal is received at the antenna 330 and fed through the circulator 320 to the 3-port element 340. In the 3-port element the signal is, by a power divider 342, divided into two parts. One part is fed to an energy harvester 344 for energy harvesting and storing of the harvested energy in a battery 350 (which could be external to the transceiver). Another part is fed to the receive chain 360 where analog SI cancellation 362 and digital SI cancelation 364 is applied to obtain a decoded signal 370.

In view of the above, there is still a need for improved techniques for wireless power transfer to UEs.

### SUMMARY

An object of embodiments herein is to address the above issues.

One particular issue pertains to how to perform SWIPT in FD D-MIMO systems with low complexity.

One particular issue pertains to how to improve the frame structures illustrated in FIG. 2 to improve the performance of SWIPT in FD D-MIMO systems.

One particular issue pertains to how to enable the receiver of the UEs to be reduced whilst still be capable of performing SWIPT in FD D-MIMO systems.

A particular object is therefore to address these particular issues.

According to a first aspect there is presented a method for wireless power transfer from APs to UEs. The APs provide network access in a D-MIMO network to the UEs. The D-MIMO network is operated in TDD mode. The method is performed by a centralized node in the D-MIMO network. The method comprises sending UE-configuration destined to the UEs. The UE-configuration instructs the UEs to, during a time interval of a frame, simultaneously transmit uplink pilot signals and perform wireless energy harvesting on energy signals. The method comprises sending AP-configuration to the APs. The AP-configuration instructs the APs to, during the time interval of the frame, simultaneously transmit the energy signals towards the UEs and receive the uplink pilot signals from the UEs.

According to a second aspect there is presented a centralized node for wireless power transfer from APs, to UEs. The APs provide network access in a D-MIMO network to the UEs. The D-MIMO network is operated in TDD mode. The centralized node comprises processing circuitry. The processing circuitry is configured to cause the centralized node to send UE-configuration destined to the UEs. The UE-configuration instructs the UEs to, during a time interval of a frame, simultaneously transmit uplink pilot signals and perform wireless energy harvesting on energy signals. The processing circuitry is configured to cause the centralized node to send AP-configuration to the APs. The AP-configuration instructs the APs to, during the time interval of the frame, simultaneously transmit the energy signals towards the UEs and receive the uplink pilot signals from the UEs.

According to a third aspect there is presented a computer program for wireless power transfer from APs to UEs, the computer program comprising computer program code which, when run on processing circuitry of a centralized, causes the centralized node to perform a method according to the first aspect.

According to a fourth aspect there is presented a method for wireless power transfer from an AP to UEs. The AP provides network access in a D-MIMO network to the UEs. The D-MIMO network is operated in TDD mode. The method is performed by the AP. The method comprises receiving UE-configuration destined to the UEs from a centralized node in the D-MIMO network. The UE-configuration instructs the UEs to, during a time interval of a frame, simultaneously transmit uplink pilot signals and perform wireless energy harvesting on energy signals. The method comprises forwarding the UE-configuration to the UEs. The method comprises receiving AP-configuration from the centralized node. The AP-configuration instructs the AP to, during the time interval of the frame, simultaneously transmit the energy signals towards the UEs and receive the uplink pilot signals from the UEs. The method comprises simultaneously, during the time interval of the frame, transmitting the energy signals towards the UEs and receiving the uplink pilot signals from the UEs.

According to a fifth aspect there is presented an AP for wireless power transfer to UEs. The AP provides network access in a D-MIMO network to the UEs. The D-MIMO network is operated in TDD mode. The AP comprises processing circuitry. The processing circuitry is configured to cause the AP to receive UE-configuration destined to the UEs from a centralized node in the D-MIMO network. The UE-configuration instructs the UEs to, during a time interval of a frame, simultaneously transmit uplink pilot signals and perform wireless energy harvesting on energy signals. The processing circuitry is configured to cause the AP to forward the UE-configuration to the UEs. The processing circuitry is configured to cause the AP to receive AP-configuration from the centralized node. The AP-configuration instructs the AP to, during the time interval of the frame, simultaneously transmit the energy signals towards the UEs and receive the uplink pilot signals from the UEs. The processing circuitry is configured to cause the AP to simultaneously, during the time interval of the frame, transmit the energy signals towards the UEs and receive the uplink pilot signals from the UEs.

According to a sixth aspect there is presented a computer program for wireless power transfer to UEs, the computer program comprising computer program code which, when run on processing circuitry of an AP, causes the AP to perform a method according to the fourth aspect.

According to a seventh aspect there is presented a method for wireless power transfer to a UE, to which network access is provided by APs in a D-MIMO network. The D-MIMO network is operated in TDD mode. The method is performed by the UE. The method comprises receiving UE-configuration originating from a centralized node in the D-MIMO network from one of the APs. The UE-configuration instructs the UE to, during a time interval of a frame, simultaneously transmit uplink pilot signals and perform wireless energy harvesting on energy signals received from the APs. The method comprises simultaneously, during the time interval of the frame, transmitting the uplink pilot signals and performing wireless energy harvesting on the energy signals received from the APs.

According to an eighth aspect there is presented a UE for wireless power transfer. Network access is provided to the UE by APs in a D-MIMO network. The D-MIMO network is operated in TDD mode. The UE comprises processing circuitry. The processing circuitry is configured to cause the UE to receive UE-configuration originating from a centralized node in the D-MIMO network from one of the APs. The UE-configuration instructs the UE to, during a time interval of a frame, simultaneously transmit uplink pilot signals and perform wireless energy harvesting on energy signals received from the APs. The processing circuitry is configured to cause the UE to simultaneously, during the time interval of the frame, transmit the uplink pilot signals and perform wireless energy harvesting on the energy signals received from the APs.

According to a tenth aspect there is presented a computer program for wireless power transfer, the computer program comprising computer program code which, when run on processing circuitry of a UE, causes the UE to perform a method according to the seventh aspect.

According to an eleventh aspect there is presented a computer program product comprising a computer program according to at least one of the third aspect, the sixth aspect, and the tenth aspect and a computer readable storage medium on which the computer program is stored. The computer readable storage medium can be a non-transitory computer readable storage medium.

Advantageously, these aspects provide efficient techniques for wireless power transfer to UEs.

Advantageously, these aspects enable more resources to be dedicated for uplink pilot signals, data, and energy transmissions and therefore, potentially, improve channel estimation, spectral efficiency, and harvested energy. Hence, aspects enable SWIPT to be performed in FD D-MIMO systems with low complexity. These aspects therefore also improve the frame structures illustrated in FIG. 2.

Advantageously, in contrast to traditional transceivers, these aspects require the UEs to only comprise a switch to select between energy harvesting and reception of downlink data transmission. Hence, aspects enable SWIPT to be performed in FD D-MIMO systems with low complexity. These aspects therefore also improve the frame structures illustrated in FIG. 2. These aspects therefore also enable the receiver of the UEs to be reduced whilst still be capable of performing SWIPT in FD D-MIMO systems.

Advantageously, by means of using different frame structures, these aspects can be used to optimize different system key performance indicators (KPIs), such as the minimum user spectral efficiency. Hence, aspects enable SWIPT to be performed in FD D-MIMO systems with low complexity. These aspects therefore also improve the frame structures illustrated in FIG. 2. These aspects therefore also enable the receiver of the UEs to be reduced whilst still be capable of performing SWIPT in FD D-MIMO systems.

Advantageously, these aspects are energy efficient in the sense that UEs can use the harvested energy to transmit uplink pilot signals and uplink data, thus saving energy. Hence, aspects enable SWIPT to be performed in FD D-MIMO systems with low complexity. These aspects therefore also improve the frame structures illustrated in FIG. 2.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 is a schematic illustration of frame structures according to examples;

FIG. 3 is a schematic illustration of a transceiver according to an example;

FIGS. 4, 6, and 7 are flowcharts of methods according to embodiments;

FIG. 5 is a schematic illustration of frame structures according to embodiments;

FIG. 8 is a schematic illustration of a transceiver according to an embodiment;

FIGS. 9, 10, and 11 are signalling diagrams according to embodiments;

FIG. 12 is a schematic diagram showing functional units of a centralized node according to an embodiment;

FIG. 13 is a schematic diagram showing functional modules of a centralized node according to an embodiment;

FIG. 14 is a schematic diagram showing functional units of an AP according to an embodiment;

FIG. 15 is a schematic diagram showing functional modules of an AP according to an embodiment;

FIG. 16 is a schematic diagram showing functional units of a UE according to an embodiment;

FIG. 17 is a schematic diagram showing functional modules of a UE according to an embodiment; and

FIG. 18 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As disclosed above, there is still a need for improved techniques for wireless power transfer to UEs.

According to the embodiments disclosed herein alternative frame structures that are optimized for SWIPT in FD D-MIMO systems are proposed. Instead of dedicating part of the frame for energy transmission or splitting the energy using a very complex radio frequency signal splitter, the proposed frame structures allows the UEs to transmit uplink pilot signals and uplink data information whilst simultaneously receiving energy from the APs and other UEs. Thus, more resources are available for uplink pilot signals and data transmission. Further, the UEs can take advantage of SI for harvesting energy. Furthermore, no energy harvesting is performed whilst the UEs receive downlink data. Therefore, the UEs do not need to perform any SI canceling, which reduces the hardware complexity at the UE-side.

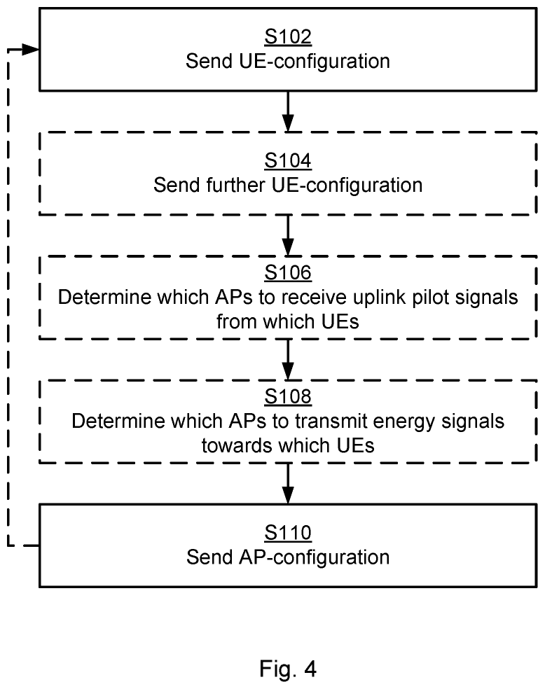

Reference is now made to FIG. 4 illustrating a method for wireless power transfer from APs 1400a:1400K to UEs 1600a:1600M. The APs 1400a:1400K provide network access in a D-MIMO network 100 to the UEs 1600a:1600M. The D-MIMO network 100 is operated in TDD mode. The method is performed by a centralized node 1200a, 1200b in the D-MIMO network 100.

In general terms, the centralized node 1200a, 1200b configures the APs 1400a:1400K to transmit energy signals towards the UEs 1600a:1600M whilst the APs 1400a:1400K are receiving uplink pilot signals from the UEs 1600a:1600M.

S102: The centralized node 1200a, 1200b sends UE-configuration destined to the UEs 1600a:1600M. The UE-configuration instructs the UEs 1600a:1600M to, during a time interval of a frame, simultaneously transmit uplink pilot signals and perform wireless energy harvesting on energy signals.

S110: The centralized node 1200a, 1200b sends AP-configuration to the APs 1400a:1400K. The AP-configuration instructs the APs 1400a:1400K to, during the time interval of the frame, simultaneously transmit the energy signals towards the UEs 1600a:1600M and receive the uplink pilot signals from the UEs 1600a:1600M. Embodiments relating to further details of wireless power transfer from APs 1400a:1400K to UEs 1600a:1600M as performed by the centralized node 1200a, 1200b will now be disclosed.

In some aspects, the centralized node 1200a, 1200b, for each UE 1600m, selects a subset cluster of APs 1400a:1400K to which the UE 1600m will transmit to. In particular, in some embodiments, the centralized node 1200a, 1200b is configured to perform (optional) step S106.

S106: The centralized node 1200a, 1200b determines which of the APs 1400a:1400K to receive the uplink pilot signals from which of the UEs 1600a:1600M. The AP-configuration then identifies which of the APs 1400a:1400K to receive the uplink pilot signals from which of the UEs 1600a:1600M.

In some aspects, the centralized node 1200a, 1200b, informs each UE 1600m about its selected cluster of APs 1400a:1400K. In particular, in some embodiments, the centralized node 1200a, 1200b is configured to perform (optional) step S104.

S104: The centralized node 1200a, 1200b sends further UE-configuration destined to the UEs 1600a:1600M. The further UE-configuration identifies which of the UEs 1600a:1600M to transmit the uplink pilot signals to which of the APs 1400a: 1400K.

In some aspects, the centralized node 1200a, 1200b, selects which APs 1400a: 1400K to perform the energy transfer. In particular, in some embodiments, the centralized node 1200a, 1200b is configured to perform (optional) step S108.

S108: The centralized node 1200a, 1200b determines which of the APs 1400a:1400K to transmit the energy signals towards the UEs 1600a:1600M. The AP-configuration then identifies which of the APs 1400a:1400K to transmit the energy signals towards the UEs 1600a:1600M.

There could be different ways in which the UE-configuration and the AP-configuration (as well as the further UE-configuration) are provided. In some embodiments, the UE-configuration and the AP-configuration (as well as the further UE-configuration) are provided as a frame structure indicator.

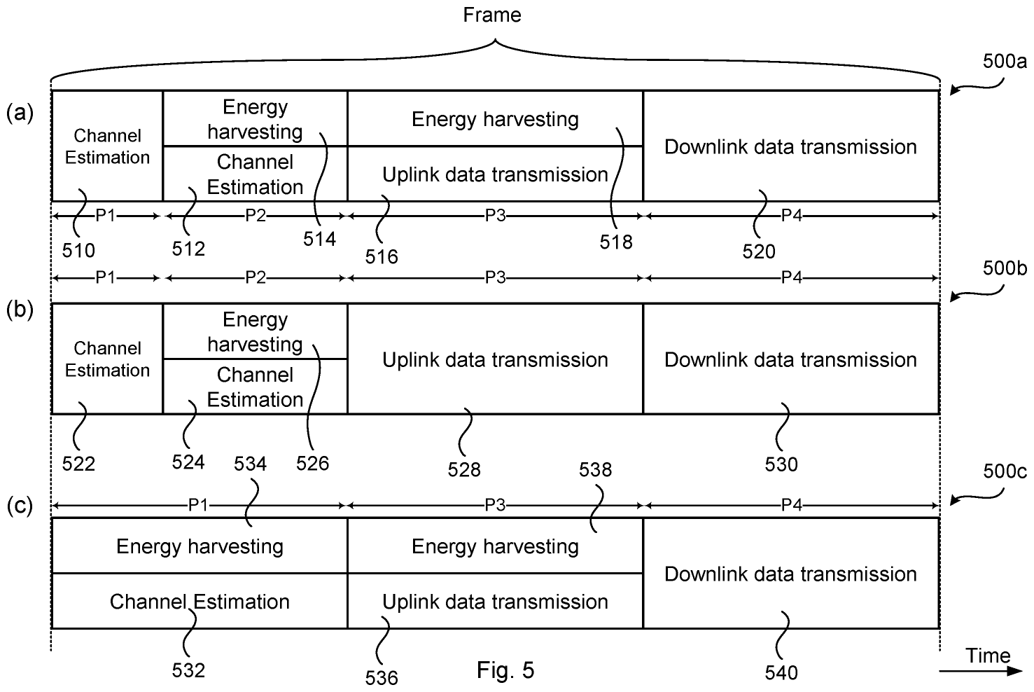

There could be different types of frames. Frame structures 500a, 500b, 500c according to three embodiments that all fulfil the above specified AP-configuration and UE-configuration (and further UE-configuration) are illustrated in FIG. 5. These frame structures also have in common that they have either three parts or four parts. Thus, in some examples, the frame is of a structure that time-wise is divided into three or four parts. The three frame structures in FIG. 5 will now be described in turn.

Reference is first made to the frame structure in FIG. 5(a).

According to the frame structure in FIG. 5(a), energy harvesting is performed in the second part and in the third part. The time interval specified in the AP-configuration and the UE-configuration therefore in this embodiment defines a second occurring part of the frame.

According to the frame structure in FIG. 5(a), the first part P1 involves channel estimation 510 where the APs 1400a:1400K measure on uplink pilot signals transmitted by the UEs 1600a:1600M. The channel estimation is used for designing precoding vectors in the second part. That is, in the first part, only channel estimation is performed where all UEs 400a:300M send their uplink pilot signals towards the APs 1400a:1400K. The APs 1400a:1400K or the centralized nodes 1200a, 1200b, estimate the channels to design precoding vectors for effective energy transfer during the second part. Hence, according to the present embodiment, according to the UE-configuration, the UEs 1600a:1600M are instructed to transmit the uplink pilot signals also during a first occurring part of the frame. According to the AP-configuration, the APs 1400a:1400K are instructed to receive the uplink pilot signals from the UEs 1600a:1600M also during the first occurring part of the frame.

Combined energy harvesting 514 and channel estimation 512 is performed in the second part P2 where all UEs 1600a:1600M send their uplink pilot signals towards the APs 1400a:1400K for a new channel estimation, which is used to design precoding and/or decoding vectors for effective energy transfer and data reception in the third part.

According to the frame structure in FIG. 5(a), the third part P3 involves energy harvesting 518 and uplink data transmission 516. Hence, according to the present embodiment, according to the UE-configuration, the UEs 1600a:1600M are instructed to simultaneously transmit uplink data signals and perform wireless energy harvesting on uplink data signals received from other UEs 1600a:1600M during a third occurring part of the frame. According to the AP-configuration, the APs 1400a:1400K are instructed to receive the uplink data signals from the UEs 1600a:1600M during the third occurring part of the frame. That is, in the third part, all UEs 400a:300M send their uplink data signals whilst simultaneously harvesting energy from the APs 1400a:1400K and interfering other UEs 400a:300M.

According to the frame structure in FIG. 5(a), the fourth part P4 involves downlink data transmission 520. Hence, according to the present embodiment, according to the AP-configuration, the APs 1400a:1400K are instructed to transmit downlink data signals towards the UEs 1600a:1600M during a fourth occurring part of the frame. According to the UE-configuration, the UEs 1600a:1600M are instructed to receive the downlink data signals during the fourth occurring part of the frame. That is, in the fourth part, the APs 1400a:1400K transmit theirs downlink data signals to the UEs 1600a:1600M in half-duplex mode, using the precoder vectors obtained by the channel estimation in the second part.

Reference is next made to the frame structure in FIG. 5(b).

According to the frame structure in FIG. 5(b), energy harvesting is performed only in the second part. The time interval specified in the AP-configuration and the UE-configuration therefore in this embodiment defines a second occurring part of the frame.

According to the frame structure in FIG. 5(b), the first part P1 involves channel estimation 522 where the APs 1400a:1400K measure on uplink pilot signals transmitted by the UEs 1600a:1600M. Hence, according to the present embodiment, according to the UE-configuration, the UEs 1600a:1600M are instructed to transmit the uplink pilot signals also during a first occurring part of the frame. According to the AP-configuration, the APs 1400a:1400K are instructed to receive the uplink pilot signals from the UEs 1600a:1600M also during the first occurring part of the frame.

Combined energy harvesting 526 and channel estimation 524 is performed in the second part P2 where all UEs 1600a:1600M send their uplink pilot signals towards the APs 1400a:1400K for a new channel estimation, which is used to design precoding and/or decoding vectors for effective energy transfer and data reception in the third part.

According to the frame structure in FIG. 5(b), the third part P3 involves uplink data transmission 528. Hence, according to the present embodiment, according to the UE-configuration, the UEs 1600a:1600M are instructed to transmit uplink data signals during a third occurring part of the frame. According to the AP-configuration, the APs 1400a:1400K are instructed to receive the uplink data signals from the UEs 1600a:1600M during the third occurring part of the frame. Only uplink data transmission is performed in the third part to minimize the interference levels in the system and improve the spectral efficiency.

According to the frame structure in FIG. 5(b), the fourth part P4 involves downlink data transmission 530. Hence, according to the present embodiment, according to the AP-configuration, the APs 1400a:1400K are instructed to transmit downlink data signals towards the UEs 1600a:1600M during a fourth occurring part of the frame. According to the UE-configuration, the UEs 1600a:1600M are instructed to receive the downlink data signals during the fourth occurring part of the frame.

Reference is finally made to the frame structure in FIG. 5(c).

According to the frame structure in FIG. 5(c), no samples are exclusively dedicated to channel estimation. This could be the case where delayed channel estimation information is be assumed to design precoding vectors. Hence, energy harvesting is performed in the first part and in the second part of the frame. The time interval specified in the AP-configuration and the UE-configuration therefore in this embodiment defines a first occurring part of the frame.

Combined energy harvesting 534 and channel estimation 532 is performed in the first part P1 where all UEs 1600a:1600M send their uplink pilot signals towards the APs 1400a:1400K for a new channel estimation, which is used to design precoding and/or decoding vectors for effective energy transfer and data reception in the second part.

According to the frame structure in FIG. 5(c), the second part P2 involves energy harvesting 538 and uplink data transmission 536. Hence, according to the present embodiment, according to the UE-configuration, the UEs 1600a:1600M are instructed to simultaneously transmit uplink data signals and perform wireless energy harvesting on uplink data signals received from other UEs 1600a:1600M during a second occurring part of the frame. According to the AP-configuration, the APs 1400a:1400K are instructed to receive the uplink data signals from the UEs 1600a:1600M during the second occurring part of the frame.

According to the frame structure in FIG. 5(c), the third part P3 involves downlink data transmission 540. Hence, according to the present embodiment, according to the AP-configuration, the APs 1400a:1400K are instructed to transmit downlink data signals towards the UEs 1600a:1600M during a third occurring part of the frame. According to the UE-configuration, the UEs 1600a:1600M are instructed to receive the downlink data signals during the third occurring part of the frame.

This third embodiments is thus identical to the first embodiment but where the first part in the frame structure of FIG. 5(a) has been removed.

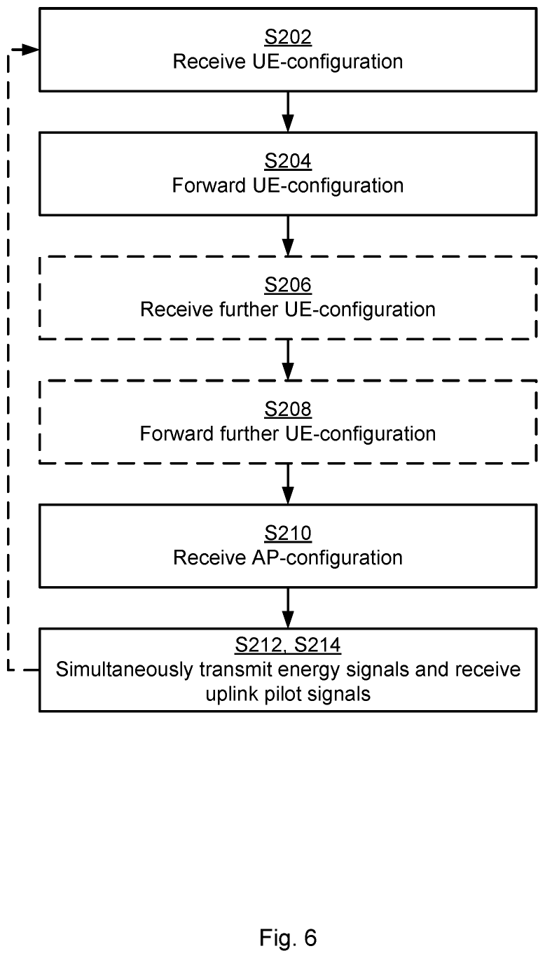

Reference is now made to FIG. 6 illustrating a method for wireless power transfer from an AP 1400k to UEs 1600a:1600M. The AP 1400k provides network access in a D-MIMO network 100 to the UEs 1600a:1600M. The D-MIMO network 100 is operated in TDD mode. The method is performed by the AP 1400k.

In general terms, the APs 1400a:1400K are configured to transmit energy signals towards the UEs 1600a:1600M whilst the APs 1400a:1400K are receiving uplink pilot signals from the UEs 1600a:1600M.

S202: The AP 1400k receives UE-configuration destined to the UEs 1600a:1600M from a centralized node 1200a, 1200b in the D-MIMO network 100. The UE-configuration instructs the UEs 1600a:1600M to, during a time interval of a frame, simultaneously transmit uplink pilot signals and perform wireless energy harvesting on energy signals.

S204: The AP 1400k forwards the UU-configuration to the UEs 1600a:1600M.

S210: The AP 1400k receives AP-configuration from the centralized node 1200a, 1200b. The AP-configuration instructs the AP 1400k to, during the time interval of the frame, simultaneously transmit the energy signals towards the UEs 1600a:1600M and receive the uplink pilot signals from the UEs 1600a:1600M.

S212, S214: The AP 1400k simultaneously, during the time interval of the frame, transmits the energy signals towards the UEs 1600a:1600M and receives the uplink pilot signals from the UEs 1600a:1600M.

Embodiments relating to further details of wireless power transfer to UEs 1600a:1600M as performed by the AP 1400k will now be disclosed.

As disclosed above, in some aspects, the centralized node 1200a, 1200b, for each UE 1600m, selects a subset cluster of APs 1400a:1400K to which the UE 1600m will transmit to. Therefore, in some embodiments, the AP-configuration identifies from of the UEs 1600a:1600M the uplink pilot signals are to be received.

As disclosed above, in some aspects, the centralized node 1200a, 1200b, informs each UE 1600m about its selected cluster of APs 1400a:1400K. Therefore, in some embodiments, the AP 1400k is configured to perform (optional) step S206.

S206: The AP 1400k receives further UE-configuration destined to the UEs 1600a:1600M from the centralized node 1200a, 1200b. The further UE-configuration identifies which of the UEs 1600a:1600M to transmit the uplink pilot signals to which APs 1400a:1400K.

S208: The AP 1400k forwards the further UE-configuration to the UEs 1600a:1600M.

The embodiments relating to the different frame structures illustrated in FIG. 5 apply also for the AP 1400k and a repeated description thereof is therefore omitted.

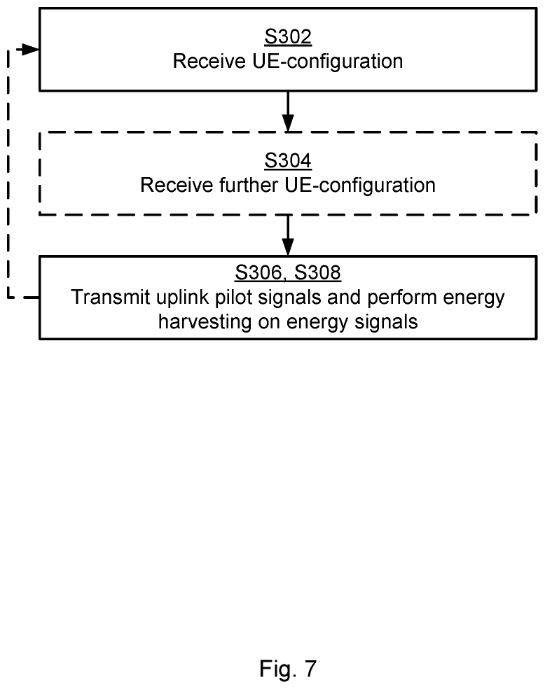

Reference is now made to FIG. 7 illustrating a method for wireless power transfer to a UE 1600m. Network access is provided to the UE 1600m by APs 1400a:1400K in a D-MIMO network 100. The D-MIMO network 100 is operated in TDD mode. The method is performed by the UE 1600m.

In general terms, the UEs 1600a:1600M receiving energy signals from the APs 1400a:1400K (and interfering UEs 1600a:1600M ) whilst transmitting uplink pilot signals towards the APs 1400a:1400K.

S302: The UE 1600m receives UE-configuration, originating from a centralized node 1200a, 1200b in the D-MIMO network 100, from one of the APs 1400a:1400K. The UE-configuration instructs the UE 1600m to, during a time interval of a frame, simultaneously transmit uplink pilot signals and perform wireless energy harvesting on energy signals received from the APs 1400a:1400K.

S306, S308: The UE 1600m simultaneously, during the time interval of the frame, transmits the uplink pilot signals and performs wireless energy harvesting on the energy signals received from the APs 1400a:1400K.

Embodiments relating to further details of wireless power transfer as performed by the UE 1600m will now be disclosed.

As disclosed above, in some aspects, the centralized node 1200a, 1200b, informs each UE 1600m about its selected cluster of APs 1400a:1400K. Therefore, in some embodiments, the UE 1600m is configured to perform (optional) step S304.

S304: The UE 1600m receives further UE-configuration originating from the centralized node 1200a, 1200b. The further UE-configuration identifies to which of the APs 1400a:1400K the uplink pilot signals are to be transmitted.

The embodiments relating to the different frame structures illustrated in FIG. 5 apply also for the UE 1600m and a repeated description thereof is therefore omitted.

In some situations, certain UEs 400a:300M may be served by APs 1400a:1400K of multiple centralized nodes 1200a, 1200b, i.e., the UEs 1600a:1600M might be operatively connected to APs 1400a:1400K that are controlled by different centralized nodes 1200a, 1200b. In such cases, the UEs 1600a:1600M could report their information for all these different centralized nodes 1200a, 1200b and information of interferent UEs 1600a:1600M should be shared by the different centralized nodes 1200a, 1200b via backhaul links that connect the different centralized nodes 1200a, 1200b.

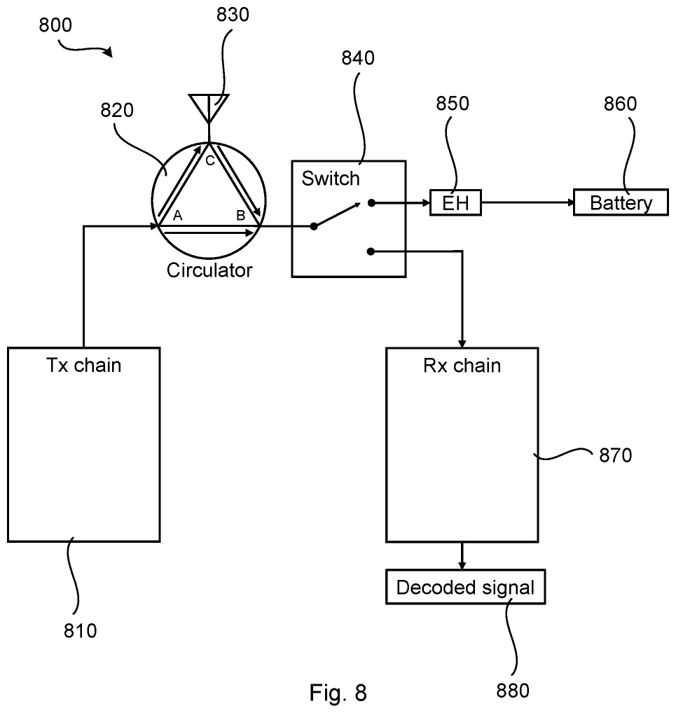

Reference is next made to FIG. 8 which schematically illustrates the transceiver 800 of a UE 1500m configured according to embodiments disclosed herein. The transceiver comprises a transmit chain 810, a receiver chain 870, a circulator 820, an antenna 830, and a switch 840. A transmit signal is fed by the transmit chain 810 through the circulator 820 to the antenna 830 for transmission. A receive signal is received at the antenna 830 and fed through the circulator 820 to the switch 840. Depending on the setting of the switch 840, the receive signal is either fed to an energy harvester 850 for energy harvesting and storing of the harvested energy in a battery (which could be external to the transceiver), or to the receive chain 870, without requiring any analog SI cancellation and digital SI cancelation, to obtain a decoded signal 880.

Three embodiments based on the frame structures in FIG. 5 will be disclosed next. In these embodiments, the centralized node 1200a, 1200b is represented by CPU-#0, the APs 1400a: 1400K are represented by AP-#0 and AP-#1 , and the UEs 1600a:1600M are represented by UE-#0 and UE-#1. In these embodiments CPU-#0 sends information to UE-#0 via AP-#0, and to UE-#0 via AP-#1 . However, the information sent from CPU-#0 to any of the UEs can be forwarded via any one or more of the APs, where the CPU-#0 is responsible for deciding which one or more APs will be used for each one or more UE.

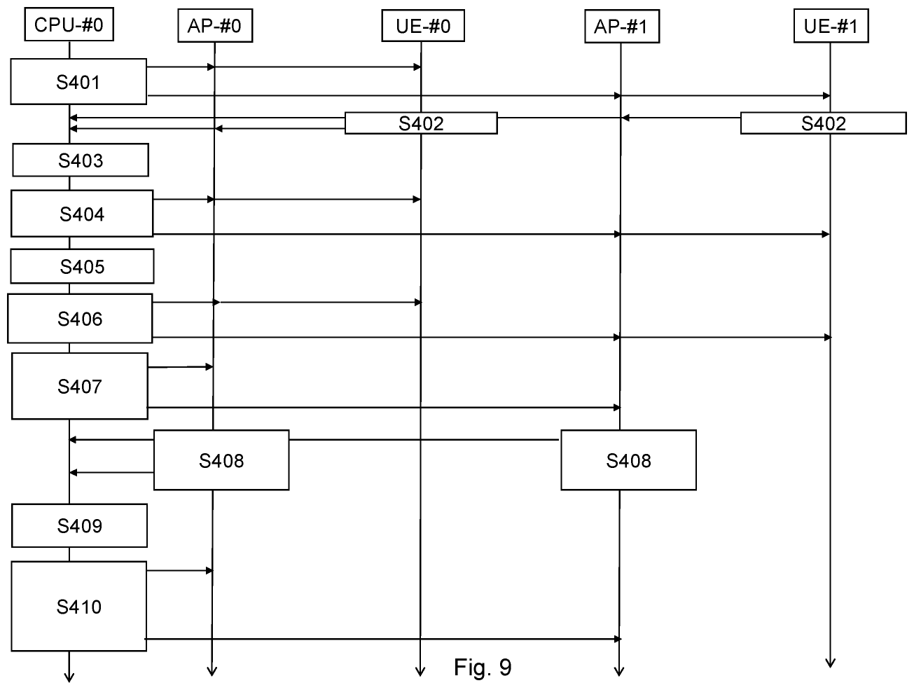

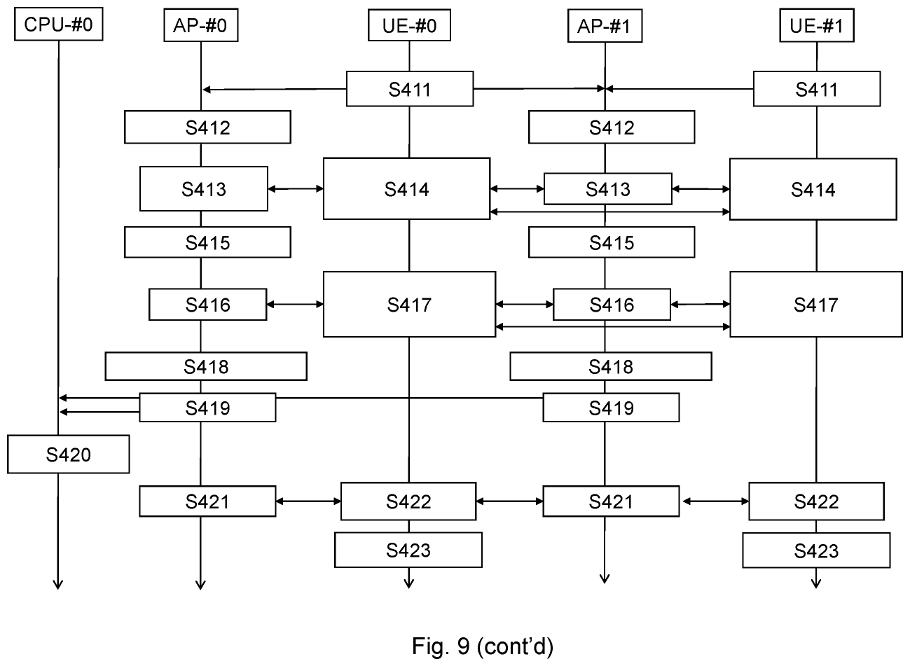

A first embodiment based on the frame structure in FIG. 5(a) will now be disclosed in detail with reference to the signalling diagram of FIG. 9.

S401: CPU-#0 sends a signal destined to UE-#0 and UE-#1 to request UE-#0 and UE-#1 to each send an uplink pilot signal, such as a preconfigured reference signal, for AP-#0 and AP-#1 to measure the link quality. The request can be sent at every T time instants, or be triggered by CPU-#0 at any time instant. The signal might be sent to UE-#0 and UE-#1 via AP-#0 and AP-#1.

S402: UE-#0 and UE-#1 each sends an uplink pilot signal, such as a preconfigured reference signal, for AP-#0 and AP-#1 to measure on.

S403: CPU-#0 allocates a pilot sequence to each of UE-#0 and UE-#1. If the number of orthogonal pilot sequences is higher than the number of UEs, each UE is assigned an orthogonal and unique pilot sequence. Otherwise, the pilot assignment can be done randomly or using known scheduling algorithms, in which more than one UE may be assigned with the same orthogonal sequence.

S404: CPU-#0 informs UE-#0 and UE-#1 of its selected pilot sequence.

S405: CPU-#0 selects for each of UE-#0 and UE-#1 a subset (cluster) of APs to which the UE will transmit to. The AP selection (or the cluster formation) can be done randomly or using known selection (clustering) algorithms.

S406: CPU-#0 informs each of UE-#0 and UE-#1 about its selected cluster of APs.

S407: CPU-#0 sends a request to AP-#0 and AP-#1 to know which of them are available to perform energy transfer.

S408: AP-#0 and AP-#1 each responds to the request. The response may contain, but is not limited to, a first indicator (such as a first flag) whether the AP is available to perform energy transfer or not, and the maximum available energy for energy transfer.

S409: CPU-#0 selects which APs will perform energy transfer. The APs can be randomly selected or using known scheduling algorithms.

S410: CPU-#0 sends a message for each AP-#0 and AP-#1 that may contain, but is not limited to, a first indicator (such as a first flag) whether the AP is selected to transmit energy or not, and a second indicator (such as a second flag) of the frame structure to be used. The indicator of the frame structure to be used is forwarded by AP-#0 and AP-#1 to UE-#0 and UE-#1.

S411: UE-#0 and UE-#1 each sends uplink pilot signals towards AP-#0 and AP-#1 in accordance with the allocated pilot sequences.

S412: AP-#0 and AP-#1 each performs local channel estimation based on the received uplink pilot signals. Based on the local channel estimation each of AP-#0 and AP-#1 designs precoding vectors for effective energy transfer. The precoding vectors can be obtained by using some predetermined precoder-book or using known precoding vectors, such as maximal-ratio-transmission (MRT).

Steps S413 and S414 are then executed in parallel.

S413: AP-#0 and AP-#1 each sends energy signal towards UE-#0 and UE-#1.

S414: UE-#0 and UE-#1 each sends uplink pilot signals towards AP-#0 and AP-#1 in accordance with the allocated pilot sequences.

Hence, AP-#0 and AP-#1 each sends energy signal towards UE-#0 and UE-#1 whilst at the same time also receiving uplink pilot signals from UE-#0 and UE-#1. Likewise, UE-#0 and UE-#1 each sends uplink pilot signals towards AP-#0 and AP-#1 whilst at the same time also receiving energy signals.

S415: AP-#0 and AP-#1 each performs local channel estimation based on the received uplink pilot signals. Based on the local channel estimation each of AP-#0 and AP-#1 designs precoding vectors for effective energy transfer, data transmission and data detection. The precoding vectors can be obtained by using some predetermined precoder-book or using known precoding vectors, such as MRT and maximum-ratio-combining (MRC).

Steps S416 and S417 are then executed in parallel.

S416: AP-#0 and AP-#1 each sends energy signal towards UE-#0 and UE-#1.

S417: UE-#0 and UE-#1 each sends uplink data signals towards AP-#0 and AP-#1.

Hence, AP-#0 and AP-#1 each sends energy signal towards UE-#0 and UE-#1 whilst at the same time also receiving uplink data signals from UE-#0 and UE-#1. Likewise, UE-#0 and UE-#1 each sends uplink data signals towards AP-#0 and AP-#1 whilst at the same time also receiving energy signals.

S418: AP-#0 and AP-#1 each performs local data estimation based on the received uplink data signals.

S419: AP-#0 and AP-#1 each sends the locally estimated data towards CPU-#0.

S420: CPU-#0 performs uplink data detection on the locally estimated data received from AP-#0 and AP-#1.

S421: AP-#0 and AP-#1 each sends downlink data signals towards UE-#0 and UE-#1.

S422: UE-#0 and UE-#1 each receives its own downlink data signal.

S423: UE-#0 and UE-#1 each decodes its own received downlink data signal.

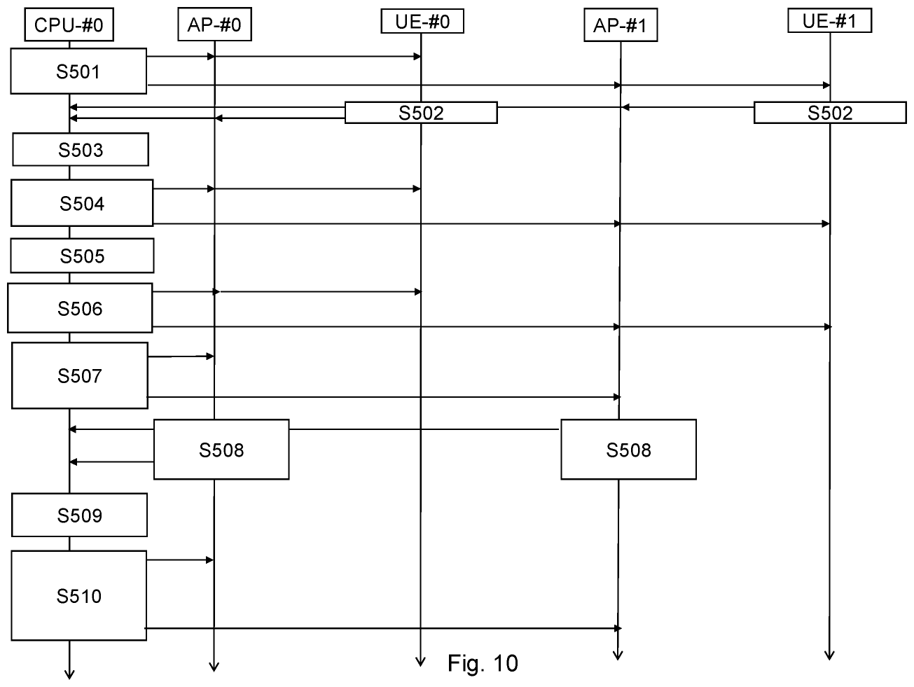

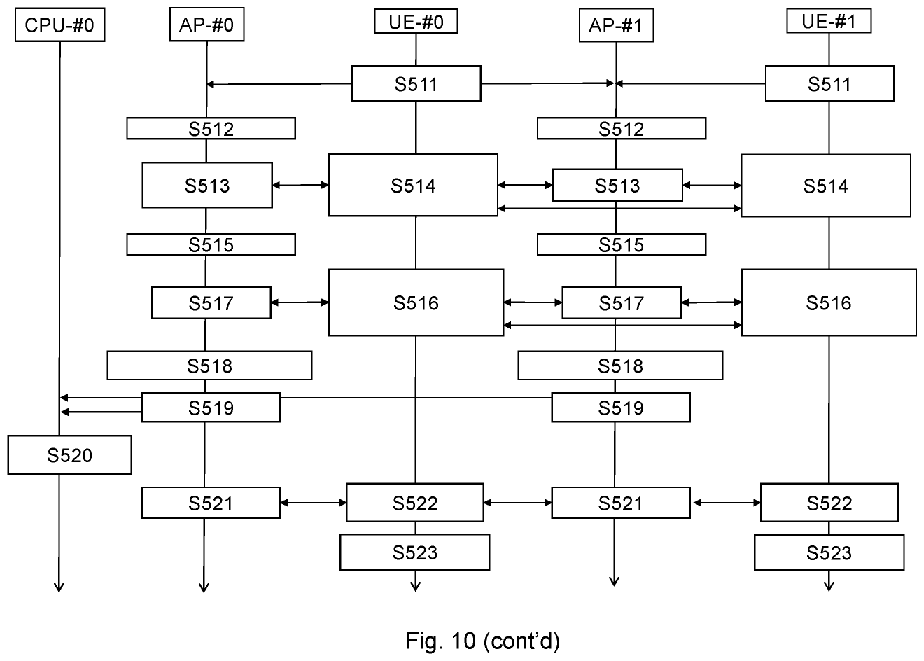

A second embodiment based on the frame structure in FIG. 5(b) will now be disclosed in detail with reference to the signalling diagram of FIG. 10.

S501: CPU-#0 sends a signal destined to UE-#0 and UE-#1 to request UE-#0 and UE-#1 to each send an uplink pilot signal, such as a preconfigured reference signal, for AP-#0 and AP-#1 to measure the link quality. The request can be sent at every T time instants, or be triggered by CPU-#0 at any time instant. The signal might be sent to UE-#0 and UE-#1 via AP-#0 and AP-#1.

S502: UE-#0 and UE-#1 each sends an uplink pilot signal, such as a preconfigured reference signal, for AP-#0 and AP-#1 to measure on.

S503: CPU-#0 allocates a pilot sequence to each of UE-#0 and UE-#1. If the number of orthogonal pilot sequences is higher than the number of UEs, each UE is assigned an orthogonal and unique pilot sequence. Otherwise, the pilot assignment can be done randomly or using known scheduling algorithms, in which more than one UE may be assigned with the same orthogonal sequence.

S504: CPU-#0 informs UE-#0 and UE-#1 of its selected pilot sequence.

S505: CPU-#0 selects for each of UE-#0 and UE-#1 a subset (cluster) of APs to which the UE will transmit to. The AP selection (or the cluster formation) can be done randomly or using known selection (clustering) algorithms.

S506: CPU-#0 informs each of UE-#0 and UE-#1 about its selected cluster of APs.

S507: CPU-#0 sends a request to AP-#0 and AP-#1 to know which of them are available to perform energy transfer.

S508: AP-#0 and AP-#1 each responds to the request. The response may contain, but is not limited to, a first indicator (such as a first flag) whether the AP is available to perform energy transfer or not, and the maximum available energy for energy transfer.

S509: CPU-#0 selects which APs will perform energy transfer. The APs can be randomly selected or using known scheduling algorithms.

S510: CPU-#0 sends a message for each AP-#0 and AP-#1 that may contain, but is not limited to, a first indicator (such as a first flag) whether the AP is selected to transmit energy or not, and a second indicator (such as a second flag) of the frame structure to be used. The indicator of the frame structure to be used is forwarded by AP-#0 and AP-#1 to UE-#0 and UE-#1.

S511: UE-#0 and UE-#1 each sends uplink pilot signals towards AP-#0 and AP-#1 in accordance with the allocated pilot sequences.

S512: AP-#0 and AP-#1 each performs local channel estimation based on the received uplink pilot signals. Based on the local channel estimation each of AP-#0 and AP-#1 designs precoding vectors for effective energy transfer. The precoding vectors can be obtained by using some predetermined precoder-book or using known precoding vectors, such as MRT.

Steps S513 and S514 are then executed in parallel.

S513: AP-#0 and AP-#1 each sends energy signal towards UE-#0 and UE-#1.

S514: UE-#0 and UE-#1 each sends uplink pilot signals towards AP-#0 and AP-#1 in accordance with the allocated pilot sequences.

Hence, AP-#0 and AP-#1 each sends energy signal towards UE-#0 and UE-#1 whilst at the same time also receiving uplink pilot signals from UE-#0 and UE-#1. Likewise, UE-#0 and UE-#1 each sends uplink pilot signals towards AP-#0 and AP-#1 whilst at the same time also receiving energy signals.

S515: AP-#0 and AP-#1 each performs local channel estimation based on the received uplink pilot signals. Based on the local channel estimation each of AP-#0 and AP-#1 designs precoding vectors for effective data transmission and data detection. The precoding vectors can be obtained by using some predetermined precoder-book or using known precoding vectors, such as MRT and maximum-ratio-combining (MRC).

S516: UE-#0 and UE-#1 each sends uplink data signals towards AP-#0 and AP-#1.

S517: AP-#0 and AP-#1 each receives the uplink data signals.

S518: AP-#0 and AP-#1 each performs local data estimation based on the received uplink data signals.

S519: AP-#0 and AP-#1 each sends the locally estimated data towards CPU-#0.

S520: CPU-#0 performs uplink data detection on the locally estimated data received from AP-#0 and AP-#1.

S521: AP-#0 and AP-#1 each sends downlink data signals towards UE-#0 and UE-#1.

S522: UE-#0 and UE-#1 each receives its own downlink data signal.

S523: UE-#0 and UE-#1 each decodes its own received downlink data signal.

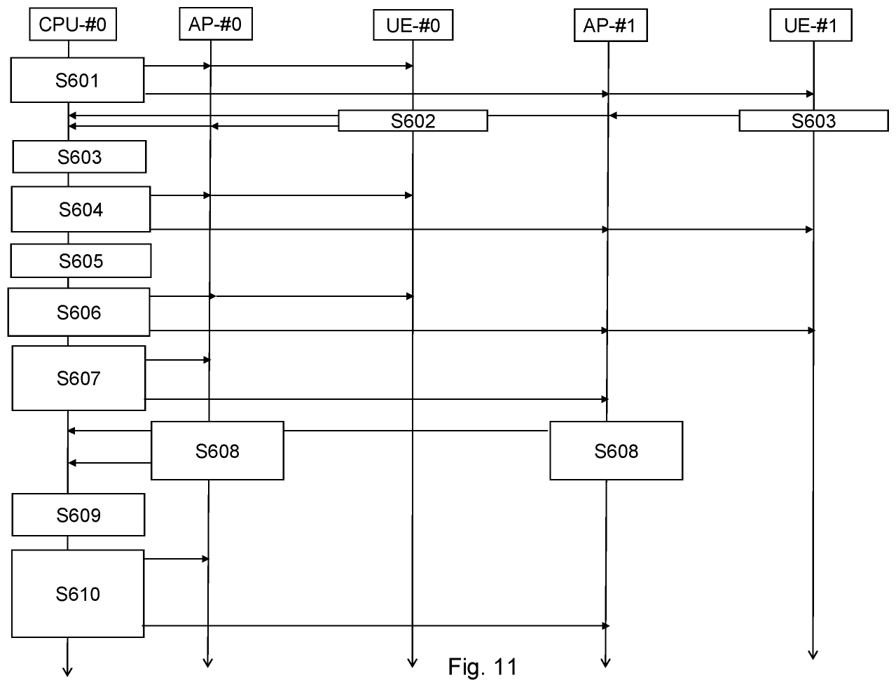

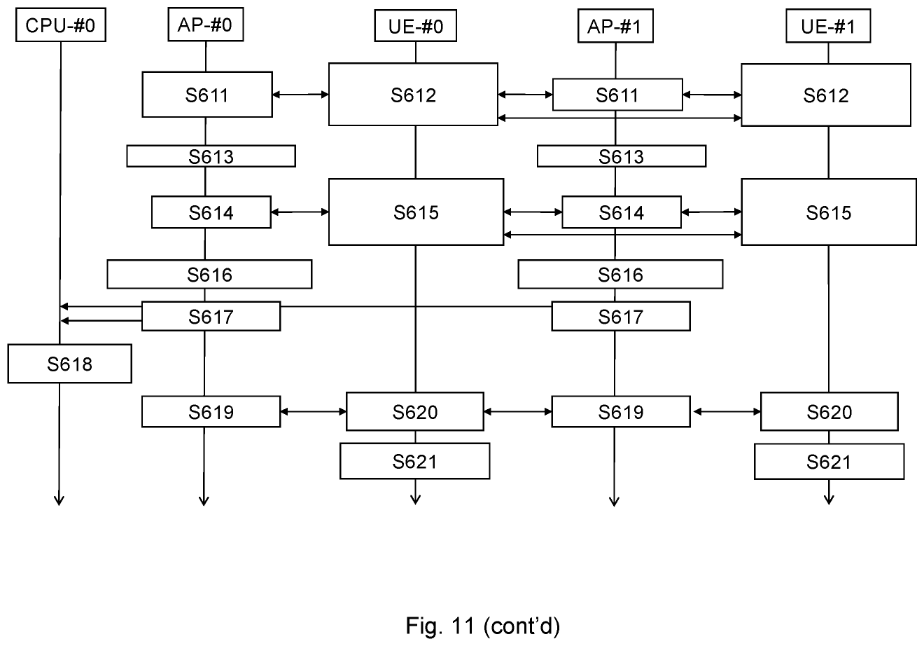

A third embodiment based on the frame structure in FIG. 5(c) will now be disclosed in detail with reference to the signalling diagram of FIG. 11.

S601: CPU-#0 sends a signal destined to UE-#0 and UE-#1 to request UE-#0 and UE-#1 to each send an uplink pilot signal, such as a preconfigured reference signal, for AP-#0 and AP-#1 to measure the link quality. The request can be sent at every T time instants, or be triggered by CPU-#0 at any time instant. The signal might be sent to UE-#0 and UE-#1 via AP-#0 and AP-#1.

S602: UE-#0 and UE-#1 each sends an uplink pilot signal, such as a preconfigured reference signal, for AP-#0 and AP-#1 to measure on.

S603: CPU-#0 allocates a pilot sequence to each of UE-#0 and UE-#1. If the number of orthogonal pilot sequences is higher than the number of UEs, each UE is assigned an orthogonal and unique pilot sequence. Otherwise, the pilot assignment can be done randomly or using known scheduling algorithms, in which more than one UE may be assigned with the same orthogonal sequence.

S604: CPU-#0 informs UE-#0 and UE-#1 of its selected pilot sequence.

S605: CPU-#0 selects for each of UE-#0 and UE-#1 a subset (cluster) of APs to which the UE will transmit to. The AP selection (or the cluster formation) can be done randomly or using known selection (clustering) algorithms.

S606: CPU-#0 informs each of UE-#0 and UE-#1 about its selected cluster of APs.

S607: CPU-#0 sends a request to AP-#0 and AP-#1 to know which of them are available to perform energy transfer.

S608: AP-#0 and AP-#1 each responds to the request. The response may contain, but is not limited to, a first indicator (such as a first flag) whether the AP is available to perform energy transfer or not, and the maximum available energy for energy transfer.

S609: CPU-#0 selects which APs will perform energy transfer. The APs can be randomly selected or using known scheduling algorithms.

S610: CPU-#0 sends a message for each AP-#0 and AP-#1 that may contain, but is not limited to, a first indicator (such as a first flag) whether the AP is selected to transmit energy or not, and a second indicator (such as a second flag) of the frame structure to be used. The indicator of the frame structure to be used is forwarded by AP-#0 and AP-#1 to UE-#0 and UE-#1.

Steps S611 and S612 are then executed in parallel.

S611: AP-#0 and AP-#1 each sends energy signal towards UE-#0 and UE-#1. The energy signals are sent using precoding vectors using delayed CSI for effective energy transfer. The precoding vectors can be obtained by using some predetermined precoder-book or using known precoding vectors, such as MRT.

S612: UE-#0 and UE-#1 each sends uplink pilot signals towards AP-#0 and AP-#1 in accordance with the allocated pilot sequences.

Hence, AP-#0 and AP-#1 each sends energy signal towards UE-#0 and UE-#1 whilst at the same time also receiving uplink pilot signals from UE-#0 and UE-#1. Likewise, UE-#0 and UE-#1 each sends uplink pilot signals towards AP-#0 and AP-#1 whilst at the same time also receiving energy signals.

S613: AP-#0 and AP-#1 each performs local channel estimation based on the received uplink pilot signals. Based on the local channel estimation each of AP-#0 and AP-#1 designs precoding vectors for effective energy transfer, data transmission and data detection. The precoding vectors can be obtained by using some predetermined precoder-book or using known precoding vectors, such as MRT and MRC.

Steps S614 and S615 are then executed in parallel.

S614: AP-#0 and AP-#1 each sends energy signal towards UE-#0 and UE- #1.

S615: UE-#0 and UE-#1 each sends uplink data signals towards AP-#0 and AP-#1 .

Hence, AP-#0 and AP-#1 each sends energy signal towards UE-#0 and UE-#1 whilst at the same time also receiving uplink data signals from UE-#0 and UE-#1. Likewise, UE-#0 and UE-#1 each sends uplink data signals towards AP-#0 and AP-#1 whilst at the same time also receiving energy signals.

S616: AP-#0 and AP-#1 each performs local data estimation based on the received uplink data signals.

S617: AP-#0 and AP-#1 each sends the locally estimated data towards CPU-#0.

S618: CPU-#0 performs uplink data detection on the locally estimated data received from AP-#0 and AP-#1.

S619: AP-#0 and AP-#1 each sends downlink data signals towards UE-#0 and UE-#1.

S620: UE-#0 and UE-#1 each receives its own downlink data signal.

S621: UE-#0 and UE-#1 each decodes its own received downlink data signal.

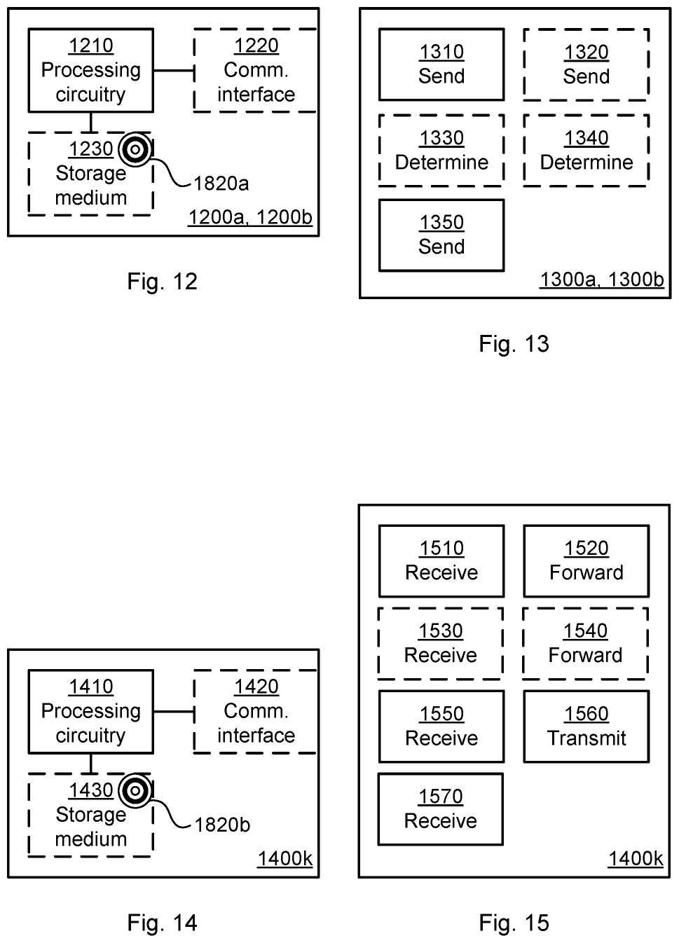

FIG. 12 schematically illustrates, in terms of a number of functional units, the components of a centralized node 1200a, 1200b according to an embodiment. Processing circuitry 1210 is provided using any combination of one or more of a suitable central processing unit (CPU), multiprocessor, microcontroller, digital signal processor (DSP), etc., capable of executing software instructions stored in a computer program product 1810a (as in FIG. 18), e.g. in the form of a storage medium 1230. The processing circuitry 1210 may further be provided as at least one application specific integrated circuit (ASIC), or field programmable gate array (FPGA).

Particularly, the processing circuitry 1210 is configured to cause the centralized node 1200a, 1200b to perform a set of operations, or steps, as disclosed above. For example, the storage medium 1230 may store the set of operations, and the processing circuitry 1210 may be configured to retrieve the set of operations from the storage medium 1230 to cause the centralized node 1200a, 1200b to perform the set of operations. The set of operations may be provided as a set of executable instructions. Thus the processing circuitry 1210 is thereby arranged to execute methods as herein disclosed.

The storage medium 1230 may also comprise persistent storage, which, for example, can be any single one or combination of magnetic memory, optical memory, solid state memory or even remotely mounted memory.

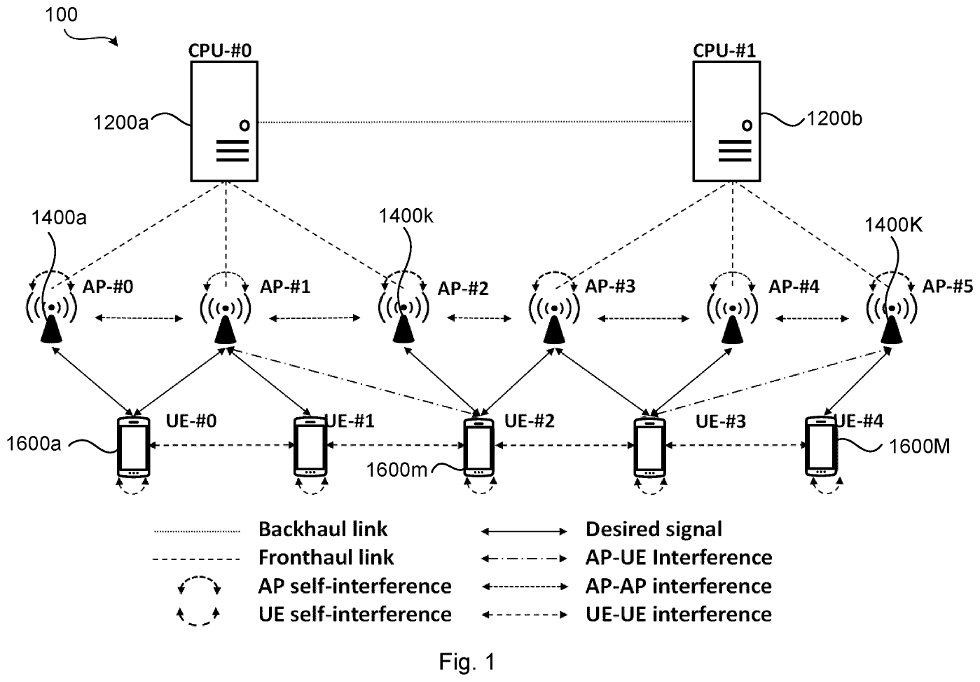

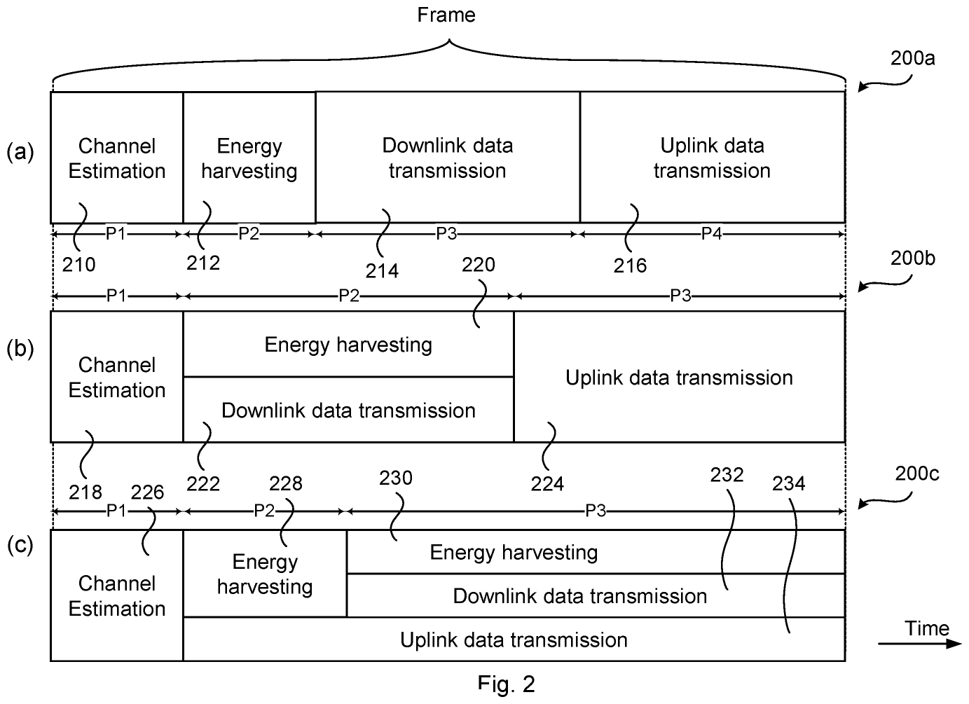

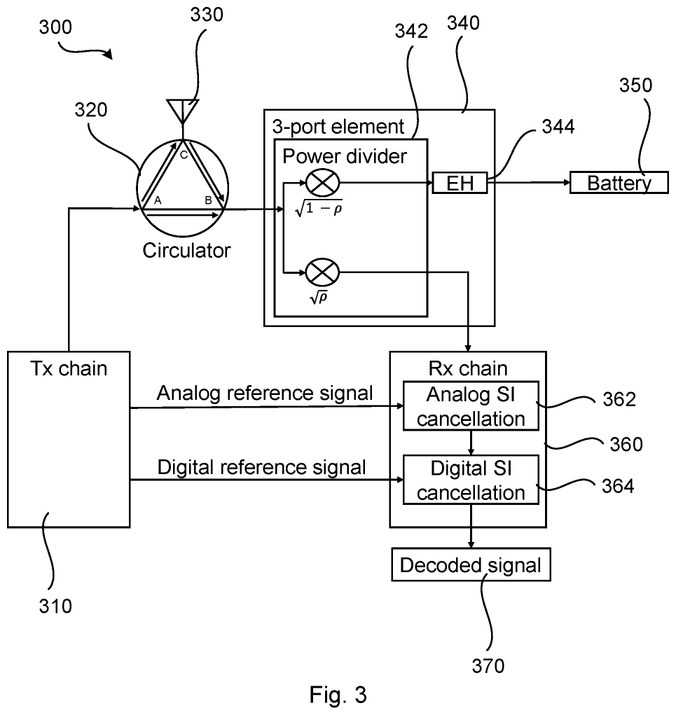

The centralized node 1200a, 1200b may further comprise a communications interface 1220 for communications with other entities, functions, nodes, and devices, as illustrated in FIG. 1. As such the communications interface 1220 may comprise one or more transmitters and receivers, comprising analogue and digital components.

The processing circuitry 1210 controls the general operation of the centralized node 1200a, 1200b e.g. by sending data and control signals to the communications interface 1220 and the storage medium 1230, by receiving data and reports from the communications interface 1220, and by retrieving data and instructions from the storage medium 1230. Other components, as well as the related functionality, of the centralized node 1200a, 1200b are omitted in order not to obscure the concepts presented herein.

FIG. 13 schematically illustrates, in terms of a number of functional modules, the components of a centralized node 1300a, 1300b according to an embodiment. The centralized node 1300a, 1300b of FIG. 13 comprises a number of functional modules; a send module 1310 configured to perform step S102, and a send module 1350 configured to perform step S110. The centralized node 1300a, 1300b of FIG. 13 may further comprise a number of optional functional modules, such as any of a send module 1320 configured to perform step S104, a determine module 1330 configured to perform step S106, and a determine module 1340 configured to perform step S108. In general terms, each functional module 1310:1350 may be implemented in hardware or in software. Preferably, one or more or all functional modules 1310:1350 may be implemented by the processing circuitry 1210, possibly in cooperation with the communications interface 1220 and the storage medium 1230. The processing circuitry 1210 may thus be arranged to from the storage medium 1230 fetch instructions as provided by a functional module 1310:1350 and to execute these instructions, thereby performing any steps of the centralized node 1300a, 1300b as disclosed herein.

The centralized node 1200a, 1200b, 1300a, 1300b may be provided as a standalone device or as a part of at least one further device. For example, the centralized node 1200a, 1200b, 1300a, 1300b may be provided in a node of the radio access network or in a node of the core network. Alternatively, functionality of the centralized node 1200a, 1200b, 1300a, 1300b may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the centralized node 1200a, 1200b, 1300a, 1300b may be executed in a first device, and a second portion of the of the instructions performed by the centralized node 1200a, 1200b, 1300a, 1300b may be executed in a second device; the herein disclosed embodiments are not limited to any particular number of devices on which the instructions performed by the centralized node 1200a, 1200b, 1300a, 1300b may be executed. Hence, the methods according to the herein disclosed embodiments are suitable to be performed by a centralized node 1200a, 1200b, 1300a, 1300b residing in a cloud computational environment. Therefore, although a single processing circuitry 1210 is illustrated in FIG. 12, the processing circuitry 1210 may be distributed among a plurality of devices, or nodes. The same applies to the functional modules 1310:1350 of FIG. 13 and the computer program 1820a of FIG. 18.

FIG. 14 schematically illustrates, in terms of a number of functional units, the components of an AP 1400k according to an embodiment. Processing circuitry 1410 is provided using any combination of one or more of a suitable central processing unit (CPU), multiprocessor, microcontroller, digital signal processor (DSP), etc., capable of executing software instructions stored in a computer program product 1810b (as in FIG. 18), e.g. in the form of a storage medium 1430. The processing circuitry 1410 may further be provided as at least one application specific integrated circuit (ASIC), or field programmable gate array (FPGA).

Particularly, the processing circuitry 1410 is configured to cause the AP 1400k to perform a set of operations, or steps, as disclosed above. For example, the storage medium 1430 may store the set of operations, and the processing circuitry 1410 may be configured to retrieve the set of operations from the storage medium 1430 to cause the AP 1400k to perform the set of operations. The set of operations may be provided as a set of executable instructions. Thus the processing circuitry 1410 is thereby arranged to execute methods as herein disclosed.

The storage medium 1430 may also comprise persistent storage, which, for example, can be any single one or combination of magnetic memory, optical memory, solid state memory or even remotely mounted memory.

The AP 1400k may further comprise a communications interface 1420 for communications with other entities, functions, nodes, and devices, as illustrated in FIG. 1. As such the communications interface 1420 may comprise one or more transmitters and receivers, comprising analogue and digital components.

The processing circuitry 1410 controls the general operation of the AP 1400k e.g. by sending data and control signals to the communications interface 1420 and the storage medium 1430, by receiving data and reports from the communications interface 1420, and by retrieving data and instructions from the storage medium 1430. Other components, as well as the related functionality, of the AP 1400k are omitted in order not to obscure the concepts presented herein.

FIG. 15 schematically illustrates, in terms of a number of functional modules, the components of an AP 1500k according to an embodiment. The AP 1500k of FIG. 15 comprises a number of functional modules; a receive module 1510 configured to perform step S202, a forward module 1520 configured to perform step S204, a receive module 1550 configured to perform step S210, a transmit module 1560 configured to perform step S212, and a receive module 1570 configured to perform step S214. The AP 1500k of FIG. 15 may further comprise a number of optional functional modules, such as any of a receive module 1530 configured to perform step S206, and a forward module 1540 configured to perform step S208. In general terms, each functional module 1510:1570 may be implemented in hardware or in software. Preferably, one or more or all functional modules 1510:1570 may be implemented by the processing circuitry 1410, possibly in cooperation with the communications interface 1420 and the storage medium 1430. The processing circuitry 1410 may thus be arranged to from the storage medium 1430 fetch instructions as provided by a functional module 1510:1570 and to execute these instructions, thereby performing any steps of the AP 1500k as disclosed herein.

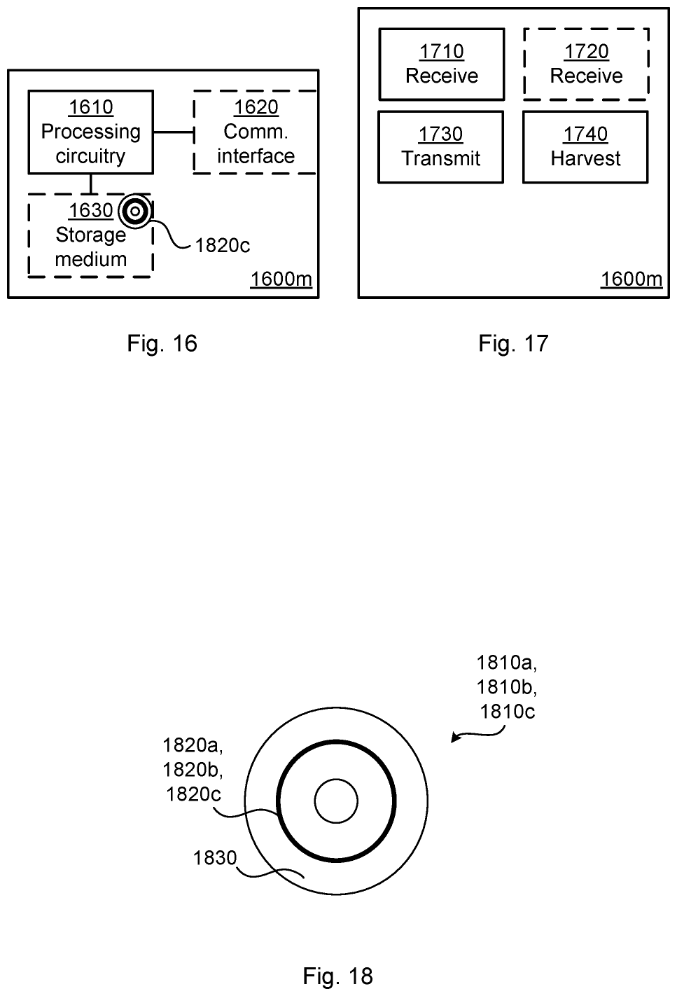

FIG. 16 schematically illustrates, in terms of a number of functional units, the components of a UE 1600m according to an embodiment. Processing circuitry 1610 is provided using any combination of one or more of a suitable central processing unit (CPU), multiprocessor, microcontroller, digital signal processor (DSP), etc., capable of executing software instructions stored in a computer program product 1810c (as in FIG. 18), e.g. in the form of a storage medium 1630. The processing circuitry 1610 may further be provided as at least one application specific integrated circuit (ASIC), or field programmable gate array (FPGA).

Particularly, the processing circuitry 1610 is configured to cause the UE 1600m to perform a set of operations, or steps, as disclosed above. For example, the storage medium 1630 may store the set of operations, and the processing circuitry 1610 may be configured to retrieve the set of operations from the storage medium 1630 to cause the UE 1600m to perform the set of operations. The set of operations may be provided as a set of executable instructions. Thus the processing circuitry 1610 is thereby arranged to execute methods as herein disclosed.

The storage medium 1630 may also comprise persistent storage, which, for example, can be any single one or combination of magnetic memory, optical memory, solid state memory or even remotely mounted memory.

The UE 1600m may further comprise a communications interface 1620 for communications with other entities, functions, nodes, and devices, as illustrated in FIG. 1. As such the communications interface 1620 may comprise one or more transmitters and receivers, comprising analogue and digital components.

The processing circuitry 1610 controls the general operation of the UE 1600m e.g. by sending data and control signals to the communications interface 1620 and the storage medium 1630, by receiving data and reports from the communications interface 1620, and by retrieving data and instructions from the storage medium 1630. Other components, as well as the related functionality, of the UE 1600m are omitted in order not to obscure the concepts presented herein.

FIG. 17 schematically illustrates, in terms of a number of functional modules, the components of a UE 1700m according to an embodiment. The UE 1700m of FIG. 17 comprises a number of functional modules; a receive module 1710 configured to perform step S302, a transmit module 1730 configured to perform step S306, and a harvest module 1740 configured to perform step S308. The UE 1700m of FIG. 17 may further comprise a number of optional functional modules, such as a receive module 1720 configured to perform step S304. In general terms, each functional module 1710:1740 may be implemented in hardware or in software. Preferably, one or more or all functional modules 1710:1740 may be implemented by the processing circuitry 1610, possibly in cooperation with the communications interface 1620 and the storage medium 1630. The processing circuitry 1610 may thus be arranged to from the storage medium 1630 fetch instructions as provided by a functional module 1710:1740 and to execute these instructions, thereby performing any steps of the UE 1700m as disclosed herein.

FIG. 18 shows one example of a computer program product 1810a, 1810b, 1810c comprising computer readable means 1830. On this computer readable means 1830, a computer program 1820a can be stored, which computer program 1820a can cause the processing circuitry 1210 and thereto operatively coupled entities and devices, such as the communications interface 1220 and the storage medium 1230, to execute methods according to embodiments described herein. The computer program 1820a and/or computer program product 1810a may thus provide means for performing any steps of the centralized node 1200a, 1200b as herein disclosed. On this computer readable means 1830, a computer program 1820b can be stored, which computer program 1820b can cause the processing circuitry 1410 and thereto operatively coupled entities and devices, such as the communications interface 1420 and the storage medium 1430, to execute methods according to embodiments described herein. The computer program 1820b and/or computer program product 1810b may thus provide means for performing any steps of the AP 1400k as herein disclosed. On this computer readable means 1830, a computer program 1820c can be stored, which computer program 1820c can cause the processing circuitry 1610 and thereto operatively coupled entities and devices, such as the communications interface 1620 and the storage medium 1630, to execute methods according to embodiments described herein. The computer program 1820c and/or computer program product 1810c may thus provide means for performing any steps of the UE 1600m as herein disclosed.

In the example of FIG. 18, the computer program product 1810a, 1810b, 1810c is illustrated as an optical disc, such as a CD (compact disc) or a DVD (digital versatile disc) or a Blu-Ray disc. The computer program product 1810a, 1810b, 1810c could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1820a, 1820b, 1820c is here schematically shown as a track on the depicted optical disk, the computer program 1820a, 1820b, 1820c can be stored in any way which is suitable for the computer program product 1810a, 1810b, 1810c.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for wireless power transfer from access points (APs) to user equipments (UEs), wherein the APs provide network access in a distributed multiple input multiple output (D-MIMO) network to the UEs, wherein the D-MIMO network is operated in time division duplex (TDD) mode, wherein the method is performed by a centralized node in the D-MIMO network, and wherein the method comprises:
sending UE-configuration destined to the UEs, the UE-configuration instructing the UEs to, during a time interval of a frame, simultaneously transmit uplink pilot signals and perform wireless energy harvesting on energy signals; and
sending AP-configuration to the APs, the AP-configuration instructing the APs to, during said time interval of the frame, simultaneously transmit the energy signals towards the UEs and receive the uplink pilot signals from the UEs

2. The method of claim 1, wherein the method further comprises:
determining which of the APs to receive the uplink pilot signals from which of the UEs, and wherein the AP-configuration identifies which of the APs to receive the uplink pilot signals from which of the UEs.

3. The method of claim 1, wherein the method further comprises:
sending further UE-configuration destined to the UEs, wherein the further UE-configuration identifies which of the UEs to transmit the uplink pilot signals to which of the APs.

4. The method of claim 1, wherein the method further comprises:
determining which of the APs to transmit the energy signals towards the UEs, and wherein the AP-configuration identifies which of the APs to transmit the energy signals towards the UEs.

5. The method of claim 1, wherein the UE-configuration and the AP-configuration are provided as a frame structure indicator.

6. The method of claim 1, wherein the frame is of a structure that is divided into parts.

7. The method of claim 1, wherein said time interval defines a second occurring part of the frame.

8-17. (canceled)

18. A method for wireless power transfer from an access point (AP) to user equipments (UEs), wherein the AP provides network access in a distributed multiple input multiple output (D-MIMO) network to the UEs, wherein the D-MIMO network is operated in time division duplex mode, wherein the method is performed by the AP, and wherein the method comprises:
receiving UE-configuration destined to the UEs from a centralized node in the D-MIMO network, the UE-configuration instructing the UEs to, during a time interval of a frame, simultaneously transmit uplink pilot signals and perform wireless energy harvesting on energy signals;
forwarding the UE-configuration to the UEs;
receiving AP-configuration from the centralized node, the AP-configuration instructing the AP to, during said time interval of the frame, simultaneously transmit the energy signals towards the UEs and receive the uplink pilot signals from the UEs; and
simultaneously, during said time interval of the frame, transmitting the energy signals towards the UEs and receiving the uplink pilot signals from the UEs.

19. The method of claim 18, wherein the AP-configuration identifies from of the UEs the uplink pilot signals are to be received.

20. The method of claim 18, wherein the method further comprises:
receiving further UE-configuration destined to the UEs from the centralized node, wherein the further UE-configuration identifies which of the UEs to transmit the uplink pilot signals to which APs; and
forwarding the further UE-configuration to the UEs.

21. A method for wireless power transfer to a user equipment, UE, to which network access is provided by access points, APs, in a distributed multiple input multiple output (D-MIMO) network, wherein the D-MIMO network is operated in time division duplex (TDD) mode, wherein the method is performed by the UE, and wherein the method comprises:
receiving UE-configuration originating from a centralized node in the D-MIMO network from one of the APs, the UE-configuration instructing the UE to, during a time interval of a frame, simultaneously transmit uplink pilot signals and perform wireless energy harvesting on energy signals received from the APs; and
simultaneously, during said time interval of the frame, transmitting the uplink pilot signals and performing wireless energy harvesting on the energy signals received from the APs.

22. The method of claim 21, wherein the method further comprises:
receiving further UE-configuration originating from the centralized node, wherein the further UE-configuration identifies to which of the APs the uplink pilot signals are to be transmitted.

23. A centralized node, the centralized node comprising:
memory; and
processing circuitry, the processing circuitry being configured to cause the centralized node to perform the method of claim 1.

24. An access point comprising memory and processing circuitry,
the processing circuitry being configured to cause the AP to perform the method of claim 18.

25. A user equipment (UE), the UE comprising:
memory; and
processing circuitry, the processing circuitry being configured to cause the UE to perform the method of claim 21.

26-29. (canceled)

30. A non-transitory computer readable storage medium storing a computer program comprising instructions for configuring a centralized node comprising processing circuitry for executing the computer instructions to perform the method of claim 1.

31. A non-transitory computer readable storage medium storing a computer program comprising instructions for configuring an access point (AP) comprising processing circuitry for executing the computer instructions to perform the method of claim 18.

32. A non-transitory computer readable storage medium storing a computer program comprising instructions for configuring a user equipment (UE) comprising processing circuitry for executing the computer instructions to perform the method of claim 21.
